(19) United States
(12) Patent Application Publication
(10) Pub. No.: US 2026/0128200 A1
(43) Pub. Date: May 7, 2026

(54) MAGNETIC ARMATURE, ELECTROMAGNETIC ACTUATOR AND METHOD FOR PRODUCING THE MAGNETIC ARMATURE

(71) Applicant: ETO MAGNETIC GMBH, Stockach (DE)

(72) Inventors: Matthias BECHLER, Singen-Friedingen (DE); Frank MAIER, Bodman-Ludwigshafen (DE)

(21) Appl. No.: 19/128,695

(22) PCT Filed: Nov. 21, 2023
(86) PCT No.: PCT/EP2023/082590

§ 371 Date: May 9, 2025

(30) Foreign Application Priority Data
Nov. 23, 2022 (DE) 10 2022 131 050.7

(51) Int. Cl. H01F 7/08; F16K 31/06

(52) U.S. Cl. CPC H01F 7/081; F16K 31/06; H01F 2007/086

(57) ABSTRACT

A magnetic armature for an electromagnetic actuator, having an outer surface and a sliding unit arranged on the outer surface for optimizing a tribological behavior, such as reducing friction and/or wear, with a magnetic armature guide unit, such as, for example, an armature guide tube or pole tube of the electromagnetic actuator, wherein the sliding unit covers only part of a total lateral surface area of the magnetic armature, in particular of an armature running surface of the magnetic armature.

### CROSS-REFERENCE TO RELATED APPLICATIONS

This patent application is a U.S. national stage application of International Patent Application PCT/EP 2023/082590, filed on Nov. 21, 2023, which is based on and claims priority to German Patent Application DE 10 2022 131 050.7, filed on Nov. 23, 2022, the contents of which are incorporated herein by reference.

### PRIOR ART

The invention relates to a magnetic armature, an electromagnetic actuator and a method for producing the magnetic armature.

It has already been proposed that magnetic armatures for electromagnetic actuators have a sliding unit arranged on an outer surface for reducing friction in a pole tube of the electromagnetic actuator.

The object of the invention is in particular to provide a generic device having advantageous properties with regard to efficiency, in particular with regard to tribological behavior and/or production complexity. The object is achieved according to the invention.

### Advantages of the Invention

The invention is based on a magnetic armature for an electromagnetic actuator, having an outer surface and a sliding unit arranged on the outer surface of the magnetic armature for optimizing a tribological behavior of the magnetic armature, such as reducing wear of the magnetic armature and/or friction of the magnetic armature with a magnetic armature guide unit of the electromagnetic actuator, such as, for example, an armature guide tube or pole tube.

It is proposed that the sliding unit covers only part of a total lateral surface area of the magnetic armature, in particular of an armature running surface of the magnetic armature. Advantageous properties with regard to the tribological behavior of the magnetic armature can thereby be achieved. Friction and/or wear of the magnetic armature as a result of a movement in the magnetic armature guide unit can advantageously be kept as low as possible. A switching cycle number of an electromagnetic actuator with the magnetic armature according to the invention can thereby advantageously be increased. The coating can advantageously be restricted to regions of the outer surface of the magnetic armature, in particular of the total lateral surface area of the magnetic armature, which regions have a touching contact with inner walls of the magnetic armature guide unit during the movement in the magnetic armature guide unit and/or in a neutral state of the magnetic armature in the magnetic armature guide unit (i.e. in particular when the magnetic armature is supported immovably in the magnetic armature guide unit). For example, during the movement of the magnetic armature in the magnetic armature guide unit or when the neutral state of the magnetic armature is present in the magnetic guide unit, a minimum tilting of the magnetic armature in the magnetic armature guide unit can occur, in particular as a result of a minimum clearance of, for example, a few hundredths of a millimeter, such that a planar magnetic armature touches the inner walls of the magnetic armature guide unit only diametrically (“top left and bottom right” or vice versa) and a remainder of an outer surface of the planar magnetic armature, in particular of the total lateral surface area of the planar magnetic armature, remains without touching the inner walls of the magnetic armature guide unit. As a rule, a magnetic armature supported with minimum clearance in the magnetic armature guide unit is never in axially continuous or full-surface contact with the inner walls of the magnetic armature guide unit, at least in a new state of the magnetic armature, but is tilted slightly. At least when a movement is started or when a movement is stopped, an increased tribological load can therefore act on the edge regions of the outer surface of the magnetic armature, in particular of the total lateral surface area of the magnetic armature. The proposed invention advantageously reduces or prevents this effect.

The magnetic armature is formed in particular as a linearly movable armature. Alternatively, however, a configuration of the magnetic armature as a rotating armature is also conceivable. In particular, the armature is configured to interact with an electromagnetic field of a magnetic coil of the electromagnetic actuator. In particular, the armature is configured to experience a force, in particular a movement force, as a result of the interaction with the electromagnetic field of the magnetic coil. Preferably, the force acting on the magnetic armature as a result of the interaction with the electromagnetic field of the magnetic coil moves the magnetic armature at least linearly along the magnet guide unit of the electromagnetic actuator. The magnetic armature forms in particular a movable magnetic core, in particular an iron core, of the electromagnetic actuator. In this case, the magnetic actuator can be formed at least partially, preferably at least to a large part, from a soft iron (sheet metal or solid material). Alternative magnetic armature materials, such as silicon-iron alloys (electrical sheet metal), nickel-iron alloys, cobalt-iron alloys, aluminum-iron alloys or ferrite materials, are likewise conceivable. In particular, the electromagnetic actuator forms an electromagnet. The magnetic armature can have an at least substantially cylindrical outer shape. Preferably, the magnetic armature is supported movably in the axial direction of the cylindrical outer shape. Preferably, the total lateral surface area of the magnetic armature forms the lateral surface area of the cylindrical outer shape of the magnetic armature. In particular, the total lateral surface area of the magnetic armature forms the so-called running surface or lateral surface area of the magnetic armature. The sliding unit is preferably formed as a component of the magnetic armature which has a substantially reduced sliding friction coefficient and/or static friction coefficient, in particular in comparison with a friction coefficient of a “bare” magnetic armature (i.e. in particular of the magnetically active material of the magnetic armature). Preferably, the sliding friction coefficient and/or the static friction coefficient is reduced by the sliding unit at least by 20%, preferably at least by 50%, in comparison with the uncovered/“bare” magnetic armature. The sliding unit can be applied to the outer surface of the magnetic armature, in particular of the magnetically active material part of the magnetic armature, by coating, painting, adhesive bonding or by a further surface application method known to the person skilled in the art. The magnetic armature guide unit is formed in particular by an armature guide tube of the electromagnetic actuator, a pole tube of the electromagnetic actuator, a core tube of the electromagnetic actuator or the like. Preferably, the magnetic coil(s) of the electromagnetic actuator is/are arranged/wound around at least one part of the magnetic armature guide unit or around the complete magnetic armature guide unit. Preferably, the magnetic armature guide unit is configured for guiding, in particular linearly guiding, the magnetic armature moved by the force generated as a result of the interaction with the electromagnetic field of the magnetic coil. “Configured” is to be understood in particular to mean specially programmed, designed and/or equipped. The fact that an object is configured for a specific function is to be understood in particular to mean that the object fulfills and/or carries out this specific function in at least one use state and/or operating state.

Furthermore, it is proposed that the sliding unit is formed by a dry lubricant layer. A high durability and/or service life can thereby advantageously be achieved. In addition, an efficient, for example inexpensive and rapid, application of the sliding unit can advantageously be made possible. The dry lubricant layer can be formed as a dry lubricant coating or as a dry lubricant paint. It is conceivable here that the dry lubricant layer is formed as a polytetrafluoroethylene (PTFE)-based dry lubricant layer, in particular a layer of PTFE dry lubricant. However, alternative dry lubricants are likewise conceivable. In particular, the magnetic armature is partially covered by the sliding unit, preferably partially coated by the dry lubricant layer, on the outer surface, in particular on the total lateral surface area, preferably at least on the running surface or the lateral surface area. The sliding unit is formed raised relative to a sliding-unit-free outer surface of the magnetic armature (minimally, for example 1 mm or less). Alternatively, however, the sliding unit could also be formed at least substantially flush with the sliding-unit-free outer surface of the magnetic armature.

If the sliding unit covers less than 75%, preferably less than 50%, preferentially less than 40% and particularly preferentially less than 30% of the total lateral surface area, a high efficiency, in particular with regard to production complexity, such as costs, material consumption and time expenditure, can advantageously be achieved. Advantageously, a material requirement, in particular a dry lubricant requirement, can be substantially reduced by merely partially covering the total lateral surface area by the sliding unit. In addition to a cost reduction, an increase in occupational safety and/or environmental compatibility can thereby advantageously be increased, in particular when the sliding unit contains materials which are critical in terms of health or environmental technology.

In addition, it is proposed that the sliding unit is arranged only in respective close regions of both axial ends of the total lateral surface area of the magnetic armature or only in a close region of an individual one of the two axial ends of the total lateral surface area of the magnetic armature. A particularly efficient protection against tribological loads, which is advantageous with regard to environmental compatibility and/or occupational safety compatibility, can thereby advantageously be achieved, in particular since in many cases the close regions of the axial ends of the magnetic armature are subjected to particularly high tribological loads. The close region preferably comprises the respective edges of the respective axial ends of the total lateral surface area. In this context, a “close region of an axial end of the total lateral surface area” is to be understood in particular to mean a region of the total lateral surface area which is formed from points of the total lateral surface area which are spaced apart from the edge of the axial end of the total lateral surface area by at most 25% of a total axial extent of the total lateral surface area, preferably by at most 15% of the total axial extent of the total lateral surface area, preferably by at most 10% of the total axial extent of the total lateral surface area and particularly preferably by at most 5% of the total axial extent of the total lateral surface area. The axial end of the total lateral surface area is formed in particular by the cylinder cover/cylinder base area lying in the axial direction of the at least substantially cylindrically formed magnetic armature.

Furthermore, it is proposed that a, in particular axial, central region of the total lateral surface area, which comprises at least 40%, preferably at least 50% and preferentially at least 60% of a total longitudinal extent of the magnetic armature, in particular in the axial direction of the magnetic armature, is formed free of the sliding unit over a total circumference of the outer surface. A particularly efficient protection against tribological loads can thereby advantageously be achieved in combination with a high cost reduction and/or good environmental and/or occupational safety compatibility. In particular, the central region of the total lateral surface area extends from an axial center, in particular from half a longitudinal extent of the magnetic armature, in both axial directions of the total lateral surface area to the same extent.

Alternatively, it is proposed that the central region of the total lateral surface area, which comprises at least 40%, preferably at least 50% and preferentially at least 60% of a total longitudinal extent of the magnetic armature, is partially covered by the sliding unit. A particularly reliable protection against tribological loads can thereby advantageously be achieved, in which a reliable reduction in friction and/or wear can be achieved in as many conceivable situations as possible, in particular positions of the magnetic armature in the magnetic armature guide unit. In particular, depending on a number of switching cycles, a contact surface of the magnetic armature with respect to the magnetic armature guide unit can widen toward the central region, such that partial covering of the total lateral surface area, in particular also within the central region, can be advantageous.

If an axial edge region of the outer surface or both axial edge regions of the outer surface is/are partially or completely covered by the sliding unit, a particularly efficient protection against tribological loads can advantageously be achieved, in particular since in many cases the axial edge regions of the magnetic armature are subjected to particularly high tribological loads. In particular, the axial edge region comprises at least the edge of the respective axial end of the magnetic armature. In particular, the sliding unit can extend beyond the edge in both axial directions, as seen from the edge. In this case, the sliding unit can extend from the lateral surface area of the cylindrical magnetic armature beyond the edge into at least a part of the base area of the cylindrical magnetic armature.

Alternatively, it is proposed that an axial edge region of the outer surface or both axial edge regions of the outer surface is/are free of a covering by the sliding unit. A secure fit of the sliding unit on the magnetic armature can thereby advantageously be ensured. Potential weakenings of the adhesion of the sliding unit to the edge can advantageously be avoided. In addition, a production efficiency can advantageously be improved, in particular by the edge region, which is significantly more complicated to provide with a planar sliding unit, being omitted during the application of the sliding unit. Production rejects can thereby advantageously be kept low.

If the sliding unit has a multiplicity of sliding elements arranged separately from one another on the outer surface, a high efficiency, in particular material efficiency and/or cost efficiency, can advantageously be achieved. A total amount of material required per magnetic armature for producing the sliding unit can advantageously be substantially reduced. The sliding elements can in this case have at least partly uniform and/or at least partly different contours. For example, it is conceivable that the sliding unit has at least two or more uniform sliding elements (provided with identical contours and dimensions). Alternatively or additionally, the sliding unit can have at least two or more different sliding elements (provided with different contours and/or dimensions).

In this context, it is proposed that at least one of the sliding elements, preferably a plurality of the sliding elements and preferentially all sliding elements, have an at least substantially circular contour or an at least substantially oval contour. A ratio of circumference to area of the individual sliding elements which is as low as possible can thereby advantageously be achieved. A “substantially circular contour” can in particular also be understood to mean a contour which has a partial circular shape, such as e.g. a semicircle, only in a partial region. A “substantially oval contour” can in particular also be understood to mean a contour which has a partial oval shape, such as e.g. a semioval, only in a partial region.

Furthermore, it is proposed that at least one of the sliding elements, preferably a plurality of the sliding elements and preferentially all sliding elements, is/are extended in a strip-shaped or band-shaped manner. An alignment of the sliding elements on the total lateral surface area, e.g. relative to the axial direction of the magnetic armature, can thereby advantageously be achieved. Particularly good tribological properties can thereby advantageously be achieved. A strip shape and/or a band shape is to be understood in particular to mean a longitudinally extended shape with a non-vanishing transverse extent. Preferably, the extent of a strip-shaped and/or band-shaped sliding element in a surface direction (direction running on the total lateral surface area) is at least three times as long as its extent in a surface direction at least substantially perpendicular thereto (a surface curvature of the total lateral surface area is to be disregarded here).

If a main extension direction of at least one of the sliding elements extended in a strip-shaped or band-shaped manner then runs at least substantially parallel to an axial direction of the, in particular cylindrical, magnetic armature, an additional movement guidance function can advantageously be achieved by the sliding unit.

If alternatively or additionally a main extension direction of at least one sliding element extended in a strip-shaped or band-shaped manner runs obliquely to an axial direction of the magnetic armature and/or if at least one of the sliding elements extended in a band-shaped manner runs at least substantially spirally around the outer surface, a particularly good covering of a large part of the total lateral surface area can advantageously be achieved with simultaneous reduction of the amount of material required for the sliding unit. In addition, a risk of tilting of the magnetic armature during a movement in the magnetic armature guide unit can thereby advantageously be reduced. In particular, a longitudinal direction of the sliding element extended in a strip-shaped or band-shaped manner runs obliquely to the axial direction by at least ±10°, preferably by at least ±20°, preferentially by at least ±30°and particularly preferentially by less than ±80°. In particular, the sliding element running spirally around the outer surface forms a right-hand spiral or a left-hand spiral. The sliding element running spirally around the outer surface area can be extended over a total axial extent of the total lateral surface area or only over a part of the total axial extent of the total lateral surface area. In addition, the total lateral surface area can comprise a plurality of spiral-shaped sliding elements. The spiral-shaped sliding element can also form a part of an interrupted spiral formed from a plurality of sliding elements. In particular, the sliding element running spirally around the outer surface area extends over at least half, preferably over at least one complete, revolution around the circumference of the total lateral surface area of the magnetic armature. The sliding elements are formed raised relative to a sliding-element-free outer surface of the magnetic armature (minimally, for example 1 mm or less). Alternatively, however, the sliding elements could also be formed at least substantially flush with the sliding-element-free outer surface of the magnetic armature.

If, in addition, at least a subset of the sliding elements exceeding the number two are arranged at least substantially regularly, in particular with one or more recurring spacing intervals, spaced apart from one another on the total lateral surface area, advantageous sliding properties of the magnetic armature can be achieved in the magnetic armature guidance unit. In addition, a further subset, for example likewise exceeding the number two, of the sliding elements can be arranged irregularly spaced apart from one another on the total lateral surface area.

In addition, an electromagnetic actuator, in particular a pneumatic valve, having the magnetic armature is proposed. A high longevity of the electromagnetic actuator, in particular linked to reduced costs and a high environmental and/or occupational safety compatibility, can thereby advantageously be achieved. In particular, the electromagnetic actuator has a high switching cycle number.

Furthermore, a method for producing the magnetic armature is proposed, wherein, in at least one production step, the sliding unit for optimizing a tribological behavior of the magnetic armature, such as reducing wear and/or friction with the magnetic armature guide unit, is applied to the outer surface of the magnetic armature, in particular by coating, adhesive bonding or painting, and wherein, in the production step, only part of a total lateral surface area of the magnetic armature, in particular of an armature running surface of the magnetic armature, is covered with the sliding unit. Advantageous properties with regard to the tribological behavior of the magnetic armature, in particular linked to reduced costs and a high environmental and/or occupational safety compatibility, can thereby be achieved. Coating is to be understood in particular to mean a production method in which a layer of a formless substance is applied to a surface of an object. In particular, the coating comprises a multiplicity of different production methods. For example, the standard according to DIN 8580:2003-09 under the main group “coating” comprises a list of conceivable production methods for applying the sliding unit.

The magnetic armature according to the invention, the electromagnetic actuator according to the invention and the method according to the invention are not intended to be restricted here to the application and embodiment described above. In particular, the magnetic armature according to the invention, the electromagnetic actuator according to the invention and the method according to the invention can have a number of individual elements, components and units differing from a number mentioned herein for fulfilling a functionality described herein.

### DRAWINGS

Further advantages result from the following description of the drawings. Ten exemplary embodiments of the invention are illustrated in the drawings. The drawings, the description and the claims contain numerous features in combination. The person skilled in the art will expediently also consider the features individually and combine them to form meaningful further combinations.

In the drawings:

FIG. 1 schematically shows an electromagnetic actuator with a magnetic armature in a lateral sectional view,

FIG. 2 shows a schematic flow diagram of a method for producing the magnetic armature,

FIG. 3 shows a schematic side view of a first alternative magnetic armature,

FIG. 4 shows a schematic side view of a second alternative magnetic armature,

FIG. 5 shows a schematic side view of a third alternative magnetic armature,

FIG. 6 shows a schematic side view of a fourth alternative magnetic armature,

FIG. 7 shows a schematic side view of a fifth alternative magnetic armature,

FIG. 8 shows a schematic side view of a sixth alternative magnetic armature,

FIG. 9 shows a schematic side view of a seventh alternative magnetic armature,

FIG. 10 shows a schematic side view of an eighth alternative magnetic armature, and

FIG. 11 shows a schematic side view of a ninth alternative magnetic armature.

### DESCRIPTION OF THE EXEMPLARY EMBODIMENTS

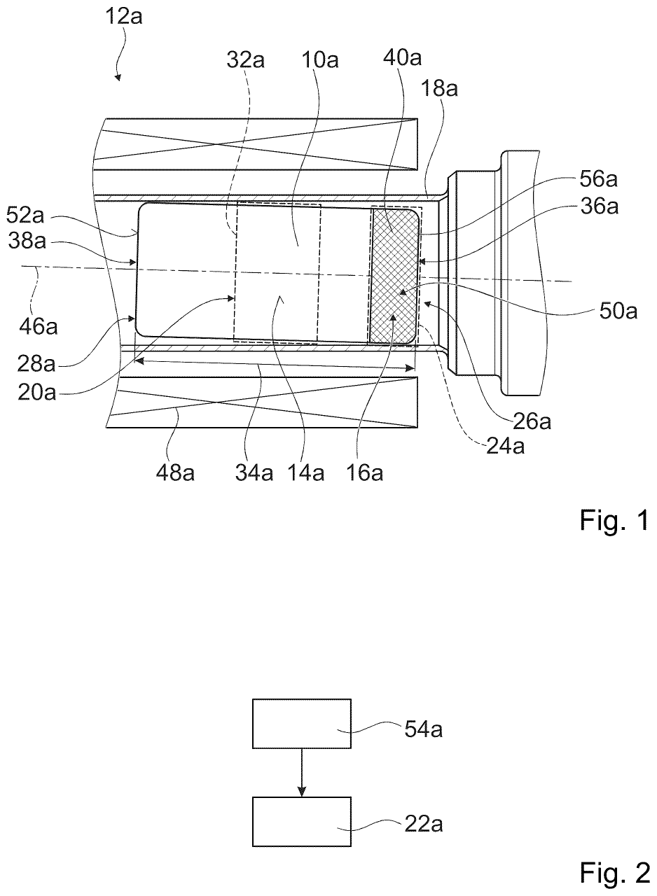

FIG. 1 schematically shows an electromagnetic actuator 12a in a lateral sectional view. The electromagnetic actuator 12a can be formed as a pneumatic valve. The electromagnetic actuator 12a is configured and designed for high switching cycle numbers. The electromagnetic actuator 12a is formed as an electromagnet. The electromagnetic actuator 12a has a magnetic coil 48a. The magnetic coil 48a is configured for generating an electromagnetic field. The electromagnetic actuator 12a has a magnetic armature 10a. The electromagnetic field of the magnetic coil 48a is configured to set the magnetic armature 10a in a linear movement. The electromagnetic actuator 12a comprises a magnetic armature guide unit 18a. The magnetic armature guide unit 18a is formed as a pole tube. The magnetic armature guide unit 18a is configured for longitudinally movably guiding a movement of the magnetic armature 10a.

The magnetic armature 10a is supported in FIG. 1 with an excessive amount of clearance in the magnetic armature guide unit 18a for illustration. The clearance that is actually present as a rule is significantly smaller. However, a frequent wear hotspot can be illustrated in this illustration. As a result of the clearance, the magnetic armature 10a can tilt slightly in the magnetic armature guide unit 18a and can thereby have preferred contact points which are frequently subjected to increased friction and therefore increased wear. The magnetic armature 10a has a cylindrical outer shape. The magnetic armature 10a has an axial direction 46a. The magnetic armature 10a has a longitudinal extension 34a in the axial direction 46a. The magnetic armature 10a has an outer surface 14a. The (cylindrical) magnetic armature 10a has a total lateral surface area 20a. The (cylindrical) magnetic armature 10a has base areas 50a, 52a.

The magnetic armature 10a has a sliding unit 16a. The sliding unit 16a is formed by one or more dry lubricant layers. The sliding unit 16a is arranged on the outer surface 14a of the magnetic armature 10a. The sliding unit 16a is arranged on the total lateral surface area 20a of the magnetic armature 10a. The sliding unit 16a is configured for optimizing a tribological behavior of the magnetic armature 10a. The sliding unit 16a is configured for reducing friction of the magnetic armature 10a with the magnetic armature guide unit 18a. The sliding unit 16a is configured for reducing wear of the magnetic armature 10a. The sliding unit 16a covers only part of the total lateral surface area 20a of the magnetic armature 10a. The sliding unit 16a covers only part of an armature running surface of the magnetic armature 10a. The sliding unit 16a covers only those parts of the total lateral surface area 20a of the magnetic armature 10a which have the highest contact probability for contact with the magnetic armature guide unit 18a. The sliding unit 16a covers less than 50% of the total lateral surface area 20a of the magnetic armature 10a. The sliding unit 16a is arranged only in a single close region 24a of an individual one of two axial ends 26a, 28a of the total lateral surface area 20a of the magnetic armature 10a. A central region 32a of the total lateral surface area 20a, which comprises at least 60% of the total longitudinal extent 34a of the magnetic armature 10a, is formed free of the sliding unit 16a over an entire circumference of the outer surface 14a. Only one axial edge region 36a of the outer surface 14a of the magnetic armature 10a is completely covered by the sliding unit 16a. A further axial edge region 38a of the outer surface 14a is free of a covering by the sliding unit 16a. The sliding unit 16a covers one of the axial edge regions 36a of the outer surface 14a of the magnetic armature 10a over the full surface area.

FIG. 2 shows a schematic flow diagram of a method for producing the magnetic armature 10a. In at least one production step 54a, the magnetic armature 10a with an uncoated surface is produced and provided. In at least one production step 22a, the sliding unit 16a is applied to the outer surface 14a of the magnetic armature 10a. In this case, in the production step 22a, only part of the total lateral surface area 20a of the magnetic armature 10a is covered by the sliding unit 16a. Subsequently, the magnetic armature 10a can be installed in the magnetic armature guide unit 18a of the electromagnetic actuator 12a.

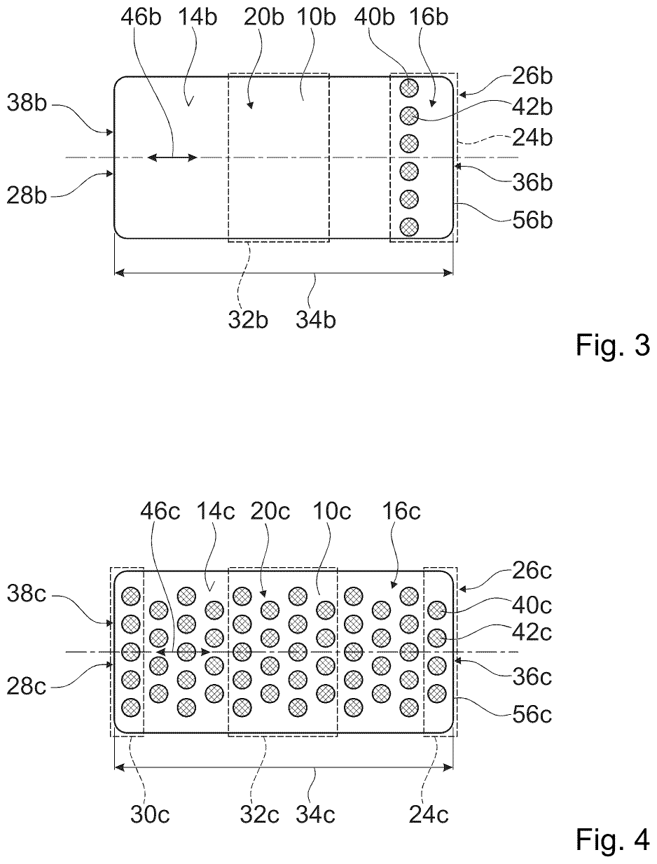

FIGS. 3 to 11 show nine further exemplary embodiments of the invention. The following descriptions and the drawings are restricted substantially to the differences between the exemplary embodiments, wherein, with regard to components with the same designation, in particular with regard to components with the same reference signs, reference can in principle also be made to the drawings and/or the description of the other exemplary embodiments, in particular of FIGS. 1 and 2. In order to distinguish between the exemplary embodiments, the letter a is placed after the reference signs of the exemplary embodiment in FIGS. 1 and 2. In the exemplary embodiments of FIGS. 3 to 11, the letter a is replaced by the letters b to j.

FIG. 3 shows a schematic side view of a first alternative magnetic armature 10b. The first alternative magnetic armature 10b has a longitudinal extension 34b. The first alternative magnetic armature 10b has a sliding unit 16b. The sliding unit 16b is arranged on an outer surface 14b of the first alternative magnetic armature 10b. The sliding unit 16b is arranged on a total lateral surface area 20b of the first alternative magnetic armature 10b. The sliding unit 16b covers only part of the total lateral surface area 20b of the first alternative magnetic armature 10b. The sliding unit 16 b covers less than 60% of the total lateral surface area 20 b of the first alternative magnetic armature 10b. The sliding unit 16b is arranged only in a single close region 24b of an individual one of two axial ends 26b, 28b of the total lateral surface area 20b of the first alternative magnetic armature 10b. A central region 32b of the total lateral surface area 20 b, which comprises at least 60% of the total longitudinal extent 34b of the first alternative magnetic armature 10b, is formed free of the sliding unit 16b over an entire circumference of the outer surface 14b. Both axial edge regions 36b, 38b of the outer surface 14b are free of a covering by the sliding unit 16b. The sliding unit 16b has a multiplicity of sliding elements 40b, 42b. The sliding elements 40b, 42b are arranged separately from one another on the outer surface 14b. A plurality of the sliding elements 40b, 42b, in the exemplary embodiment illustrated in FIG. 3 even all of the sliding elements 40b, 42b, have a circular contour. Alternatively, oval contours are also conceivable. At least a subset of the sliding elements 40b, 42b exceeding the number two are arranged spaced apart from one another in the circumferential direction at regular intervals on the total lateral surface area 20b. The sliding elements 40b, 42b of the exemplary embodiment of FIG. 3 are arranged once in the circumferential direction around the outer surface 14b of the magnetic armature 10b at virtually equal distances from an edge 56b of the first alternative magnetic armature 10b. The sliding elements 40b, 42b are formed raised relative to a sliding-element-free outer surface 14b of the first alternative magnetic armature 10b.

FIG. 4 shows a schematic side view of a second alternative magnetic armature 10c. The second alternative magnetic armature 10c has a longitudinal extension 34c. The second alternative magnetic armature 10c has a sliding unit 16c. The sliding unit 16c is arranged on an outer surface 14c of the second alternative magnetic armature 10c. The sliding unit 16c is arranged on a total lateral surface area 20c of the second alternative magnetic armature 10c. The sliding unit 16c covers only part of the total lateral surface area 20c of the second alternative magnetic armature 10c. The sliding unit 16c covers less than 50% of the total lateral surface area 20c of the second alternative magnetic armature 10c. A central region 32c of the total lateral surface area 20c, which comprises at least 40% of the total longitudinal extent 34c of the second alternative magnetic armature 10c, is partially covered by the sliding unit 16c. Both axial edge regions 36c, 38c of the outer surface 14c are free of a covering by the sliding unit 16c. The sliding unit 16c has a multiplicity of sliding elements 40c, 42c. The sliding elements 40c, 42c are arranged separately from one another on the outer surface 14c. A plurality of the sliding elements 40c, 42c, in the exemplary embodiment illustrated in FIG. 4 even all of the sliding elements 40c, 42c, have a circular contour. Alternatively, oval contours are also conceivable. At least a subset of the sliding elements 40c, 42c exceeding the number two are arranged spaced apart from one another in the circumferential direction and in the longitudinal direction at regular intervals on the total lateral surface area 20c. The sliding elements 40c, 42c of the exemplary embodiment of FIG. 4 are arranged distributed in a regular pattern over virtually the entire outer surface 14c.

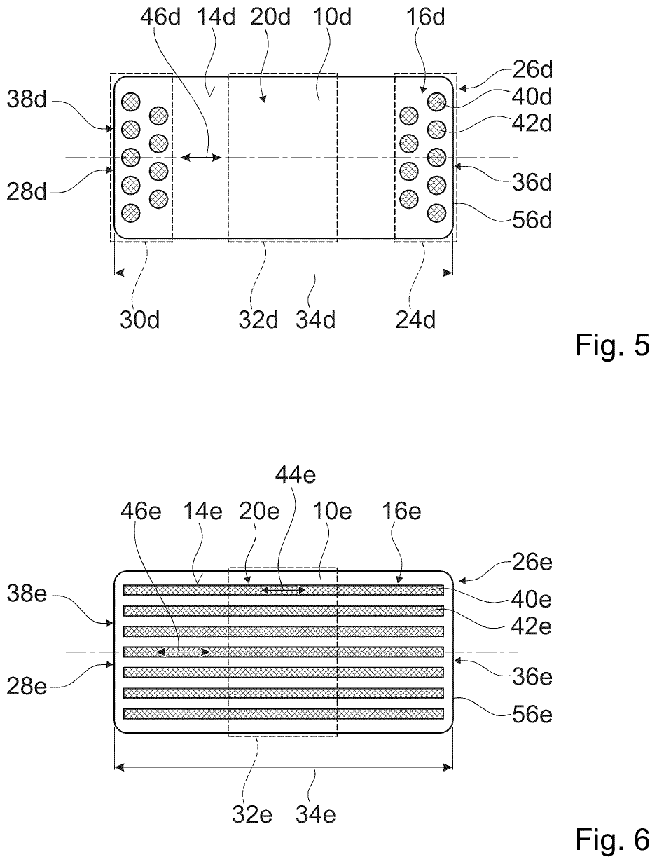

FIG. 5 shows a schematic side view of a third alternative magnetic armature 10d. The third alternative magnetic armature 10d has a longitudinal extension 34d. The third alternative magnetic armature 10d has a sliding unit 16d. The sliding unit 16d is arranged on an outer surface 14d of the third alternative magnetic armature 10d. The sliding unit 16d is arranged on a total lateral surface area 20d of the third alternative magnetic armature 10d. The sliding unit 16d covers only part of the total lateral surface area 20d of the third alternative magnetic armature 10d. The sliding unit 16d covers less than 50% of the total lateral surface area 20d of the third alternative magnetic armature 10d. A central region 32d of the total lateral surface area 20d, which comprises at least 60% of the total longitudinal extent 34d of the third alternative magnetic armature 10d, is formed free of the sliding unit 16d over an entire circumference of the outer surface 14d. Both axial edge regions 36d, 38d of the outer surface 14d are free of a covering by the sliding unit 16d. The sliding unit 16d has a multiplicity of sliding elements 40d, 42d. The sliding elements 40d, 42d are arranged separately from one another on the outer surface 14d. A plurality of the sliding elements 40d, 42d, in the exemplary embodiment illustrated in FIG. 5 even all of the sliding elements 40d, 42d, have a circular contour. Alternatively, oval contours are also conceivable. At least a subset of the sliding elements 40d, 42d exceeding the number two are arranged spaced apart from one another in the circumferential direction at regular intervals on the total lateral surface area 20d in a plurality of rings of sliding elements 40d, 42d distributed along the longitudinal direction. The sliding unit 16d is arranged only in respective close regions 24d, 30d of both axial ends 26d, 28d of the total lateral surface area 20d.

FIG. 6 shows a schematic side view of a fourth alternative magnetic armature 10e. The fourth alternative magnetic armature 10e has a longitudinal extension 34e. The fourth alternative magnetic armature 10e has a sliding unit 16e. The sliding unit 16e is arranged on an outer surface 14e of the fourth alternative magnetic armature 10e. The sliding unit 16e is arranged on a total lateral surface area 20e of the fourth alternative magnetic armature 10e. The sliding unit 16e covers only part of the total lateral surface area 20e of the fourth alternative magnetic armature 10e. The sliding unit 16e covers less than 50% of the total lateral surface area 20 e of the fourth alternative magnetic armature 10e. A central region 32e of the total lateral surface area 20e, which comprises at least 40% of the total longitudinal extent 34e of the second alternative magnetic armature 10e, is partially covered by the sliding unit 16e. Both axial edge regions 36e, 38e of the outer surface 14e are free of a covering by the sliding unit 16e. The sliding unit 16e has a multiplicity of sliding elements 40e, 42e. The sliding elements 40e, 42e are arranged separately from one another on the outer surface 14e. A plurality of the sliding elements 40e, 42e, in the exemplary embodiment illustrated in FIG. 6 even all of the sliding elements 40e, 42e, are extended in a strip-shaped and/or band-shaped manner. A main extension direction 44e of the sliding elements 40e, 42e extended in a strip-shaped and/or band-shaped manner runs at least substantially parallel to an axial direction 46e of the fourth alternative magnetic armature 10e. The at least one subset of the sliding elements 40e, 42e exceeding the number two are arranged spaced apart from one another in the circumferential direction at regular intervals on the total lateral surface area 20e in a ring of sliding elements 40e, 42e. Each of the sliding elements 40e, 42e extended in a strip-shaped and/or band-shaped manner extends over a large part, in particular over more than 80%, of the longitudinal extent 34e of the total lateral surface area 20e.

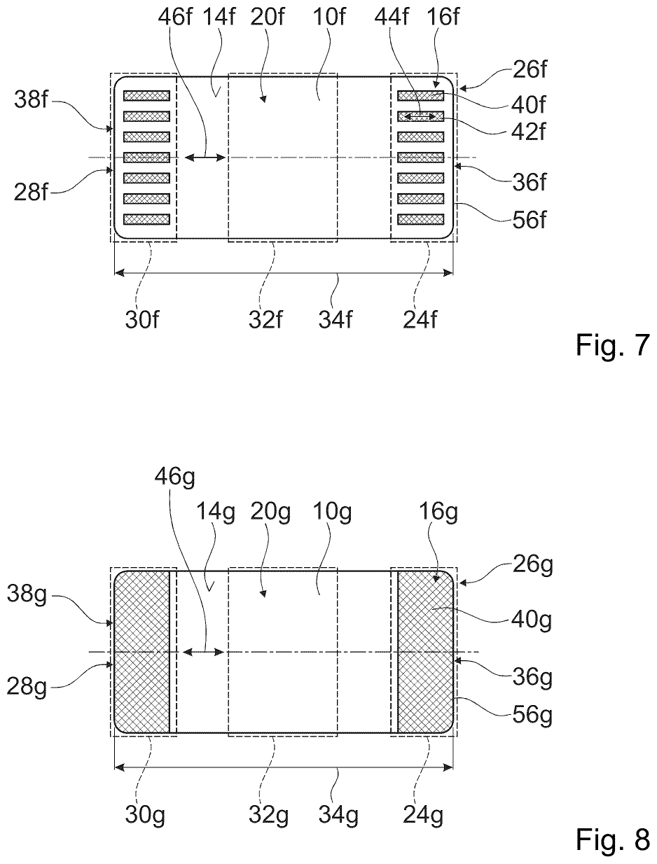

FIG. 7 shows a schematic side view of a fifth alternative magnetic armature 10f. The fifth alternative magnetic armature 10f has a longitudinal extension 34f. The fifth alternative magnetic armature 10f has a sliding unit 16f. The sliding unit 16f is arranged on an outer surface 14f of the fifth alternative magnetic armature 10f. The sliding unit 16f is arranged on a total lateral surface area 20f of the fifth alternative magnetic armature 10f. The sliding unit 16f covers only part of the total lateral surface area 20f of the fifth alternative magnetic armature 10f. The sliding unit 16 f covers less than 50% of the total lateral surface area 20 f of the fifth alternative magnetic armature 10f. A central region 32f of the total lateral surface area 20f, which comprises at least 60% of the total longitudinal extent 34 f of the fifth alternative magnetic armature 10f, is formed free of the sliding unit 16f over an entire circumference of the outer surface 14f. Both axial edge regions 36f, 38f of the outer surface 14f are free of a covering by the sliding unit 16f. The sliding unit 16f has a multiplicity of sliding elements 40f, 42f. The sliding elements 40f, 42f are arranged separately from one another on the outer surface 14f. A plurality of the sliding elements 40f, 42f, in the exemplary embodiment illustrated in FIG. 7 even all of the sliding elements 40f, 42f, are extended in a strip-shaped and/or band-shaped manner. A main extension direction 44f of the sliding elements 40f, 42f extended in a strip-shaped and/or band-shaped manner runs at least substantially parallel to an axial direction 46f of the fifth alternative magnetic armature 10f. The at least one subset of the sliding elements 40f, 42f exceeding the number two are arranged spaced apart in the circumferential direction on the total lateral surface area 20f in a plurality of rings of sliding elements 40f, 42f. Each of the sliding elements 40f, 42f extended in a strip-shaped and/or band-shaped manner in this case extends at most over a sixth of the longitudinal extent 34f of the total lateral surface area 20f. The sliding unit 16f is arranged only in respective close regions 24f, 30f of axial ends 26f, 28f of the total lateral surface area 20f. A ring of sliding elements 40f, 42f extended in a strip-shaped and/or band-shaped manner is arranged in each case at each of the axial ends 26f, 28f of the total lateral surface area 20f.

FIG. 8 shows a schematic side view of a sixth alternative magnetic armature 10g. The sixth alternative magnetic armature 10g has a longitudinal extension 34g. The sixth alternative magnetic armature 10g has a sliding unit 16g. The sliding unit 16g is arranged on an outer surface 14g of the sixth alternative magnetic armature 10g. The sliding unit 16g is arranged on a total lateral surface area 20g of the sixth alternative magnetic armature 10g. The sliding unit 16g covers only part of the total lateral surface area 20g of the sixth alternative magnetic armature 10g. The sliding unit 16g covers less than 50% of the total lateral surface area 20g of the sixth alternative magnetic armature 10g. A central region 32g of the total lateral surface area 20g, which comprises at least 60% of the total longitudinal extent 34g of the sixth alternative magnetic armature 10g, is formed free of the sliding unit 16g over an entire circumference of the outer surface 14g. Both axial edge regions 36g, 38g of the outer surface 14g are completely covered by the sliding unit 16g. The sliding unit 16g covers the two axial edge regions 36g, 38g of the outer surface 14g of the sixth alternative magnetic armature 10g over the full surface area.

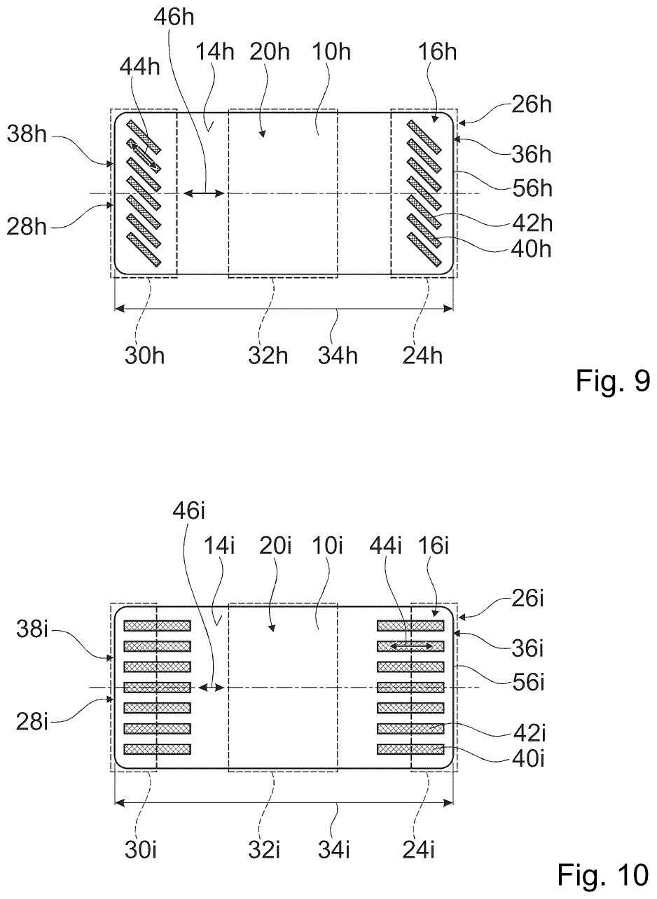

FIG. 9 shows a schematic side view of a seventh alternative magnetic armature 10h. The seventh alternative magnetic armature 10h has a longitudinal extension 34h. The seventh alternative magnetic armature 10h has a sliding unit 16h. The sliding unit 16h is arranged on an outer surface 14h of the seventh alternative magnetic armature 10h. The sliding unit 16h is arranged on a total lateral surface area 20h of the seventh alternative magnetic armature 10h. The sliding unit 16h covers only part of the total lateral surface area 20h of the seventh alternative magnetic armature 10h. The sliding unit 16h covers less than 50% of the total lateral surface area 20h of the seventh alternative magnetic armature 10h. A central region 32h of the total lateral surface area 20h, which comprises at least 60% of the total longitudinal extent 34h of the fifth alternative magnetic armature 10h, is formed free of the sliding unit 16h over an entire circumference of the outer surface 14h. Both axial edge regions 36h, 38h of the outer surface 14h are free of a covering by the sliding unit 16h. The sliding unit 16h has a multiplicity of sliding elements 40h, 42h. The sliding elements 40h, 42h are arranged separately from one another on the outer surface 14h. A plurality of the sliding elements 40h, 42h, in the exemplary embodiment illustrated in FIG. 9 even all of the sliding elements 40h, 42h, are extended in a strip-shaped and/or band-shaped manner. A main extension direction 44h of the sliding elements 40f, 42h extended in a strip-shaped and/or band-shaped manner runs obliquely to an axial direction 46h of the seventh alternative magnetic armature 10h. The at least one subset of the sliding elements 40h, 42h exceeding the number two are arranged spaced apart in the circumferential direction on the total lateral surface area 20h in a plurality of rings of sliding elements 40h, 42h. The sliding unit 16h is arranged only in respective close regions 24h, 30h of axial ends 26h, 28h of the total lateral surface area 20h. A ring of obliquely oriented sliding elements 40h, 42h extended in a strip-shaped and/or band-shaped manner is arranged in each case at each of the axial ends 26h, 28h of the total lateral surface area 20h. The sliding elements 40h, 42h of the rings extended in a strip-shaped and/or band-shaped manner are in this case angled identically to the axial direction 46h. However, a different or even opposite angling of the sliding elements 40h, 42h of the rings extended in a strip-shaped and/or band-shaped manner relative to the axial direction 46h is likewise conceivable.

FIG. 10 shows a schematic side view of an eighth alternative magnetic armature 10i. The eighth alternative magnetic armature 10i has a longitudinal extension 34i. The eighth alternative magnetic armature 10i has a sliding unit 16i. The sliding unit 16i is arranged on an outer surface 14i of the eighth alternative magnetic armature 10i. The sliding unit 16i is arranged on a total lateral surface area 20i of the eighth alternative magnetic armature 10i. The sliding unit 16i covers only part of the total lateral surface area 20i of the eighth alternative magnetic armature 10i. The sliding unit 16i covers less than 50% of the total lateral surface area 20 i of the fifth alternative magnetic armature 10i. A central region 32i of the total lateral surface area 20i, which comprises at least 50% of the total longitudinal extent 34i of the eighth alternative magnetic armature 10i, is formed free of the sliding unit 16i over an entire circumference of the outer surface 14i. Both axial edge regions 36i, 38i of the outer surface 14i are free of a covering by the sliding unit 16i. The sliding unit 16i has a multiplicity of sliding elements 40i, 42i. The sliding elements 40i, 42i are arranged separately from one another on the outer surface 14i. A plurality of the sliding elements 40i, 42i, in the exemplary embodiment illustrated in FIG. 10 even all of the sliding elements 40i, 42i, are extended in a strip-shaped and/or band-shaped manner. A main extension direction 44i of the sliding elements 40i, 42i extended in a strip-shaped and/or band-shaped manner runs at least substantially parallel to an axial direction 46i of the fifth alternative magnetic armature 10i. The at least one subset of the sliding elements 40i, 42i exceeding the number two are arranged spaced apart in the circumferential direction on the total lateral surface area 20i in a plurality of rings of sliding elements 40i, 42i. Each of the sliding elements 40i, 42i extended in a strip-shaped and/or band-shaped manner in this case extends at most over a quarter and at least over more than a sixth of the longitudinal extent 34i of the total lateral surface area 20i. The sliding unit 16i is arranged only in respective close regions 24i, 30i of axial ends 26i, 28i of the total lateral surface area 20i. A ring of sliding elements 40i, 42i extended in a strip-shaped and/or band-shaped manner is arranged in each case at each of the axial ends 26i, 28i of the total lateral surface area 20i.

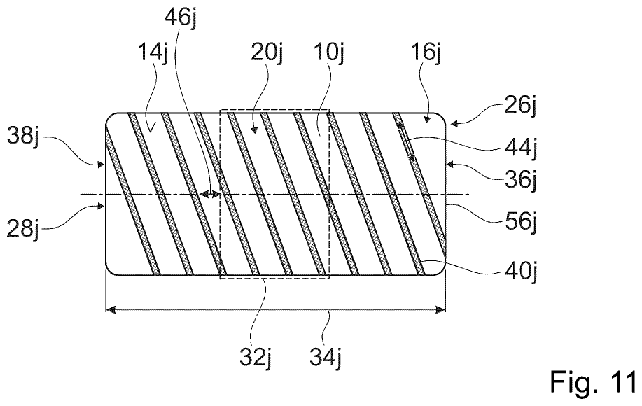

FIG. 11 shows a schematic side view of a ninth alternative magnetic armature 10j. The ninth alternative magnetic armature 10j has a longitudinal extension 34j. The ninth alternative magnetic armature 10j has a sliding unit 16j. The sliding unit 16j is arranged on an outer surface 14j of the ninth alternative magnetic armature 10j. The sliding unit 16j is arranged on a total lateral surface area 20j of the ninth alternative magnetic armature 10j. The sliding unit 16j covers only part of the total lateral surface area 20j of the ninth alternative magnetic armature 10j. The sliding unit 16j covers less than 50% of the total lateral surface area 20j of the ninth alternative magnetic armature 10j. A central region 32j of the total lateral surface area 20j, which comprises at least 60% of the total longitudinal extent 34j of the ninth alternative magnetic armature 10j, is partially covered by the sliding unit 16j. Both axial edge regions 36j, 38j of the outer surface 14j are partially covered by the sliding unit 16j. The sliding unit 16j in this case does not cover the two axial edge regions 36j, 38j of the outer surface 14j of the ninth alternative magnetic armature 10j over the full surface area. The sliding unit 16j has precisely one sliding element 40j. The sliding element 40j is extended in a strip-shaped and/or band-shaped manner. A main extension direction 44j of the sliding element 40j extended in a strip-shaped and/or band-shaped manner runs obliquely to an axial direction 46j of the ninth alternative magnetic armature 10j. The sliding element 40j extended in a band-shaped and/or strip-shaped manner runs spirally around the outer surface 14j. The sliding element 40j extended in a band-shaped and/or strip-shaped manner in this case extends over the total longitudinal extent 34j of the ninth alternative magnetic armature 10j.

1. A magnetic armature for an electromagnetic actuator, having an outer surface and a sliding unit arranged on the outer surface for optimizing a tribological behavior of the magnetic armature such as reducing wear of the magnetic armature and/or friction with a magnetic armature guide unit of the electromagnetic actuator such as, for example, an armature guide tube or pole tube, wherein the sliding unit covers only part of a total lateral surface area of the magnetic armature in particular of an armature running surface of the magnetic armature

2. The magnetic armature according to claim 1, wherein the sliding unit is formed by a dry lubricant layer.

3. The magnetic armature according to claim 1, wherein the sliding unit covers less than 75%, preferably less than 50%, preferentially less than 40% and particularly preferentially less than 30% of the total lateral surface area.

4. The magnetic armature according to claim 1, wherein the sliding unit is arranged only in respective close regions of both axial ends of the total lateral surface area or only in a close region of an individual one of the two axial ends of the total lateral surface area.

5. The magnetic armature according to claim 1, wherein a central region of the total lateral surface area which comprises at least 40%, preferably at least 50% and preferentially at least 60% of a total longitudinal extent of the magnetic armature is formed free of the sliding unit over an entire circumference of the outer surface.

6. The magnetic armature according to claim 1, wherein a central region of the total lateral surface area which comprises at least 40%, preferably at least 50% and preferentially at least 60% of a total longitudinal extent of the magnetic armature is partially covered by the sliding unit.

7. The magnetic armature according to claim 1, wherein an axial edge region of the outer surface or both axial edge regions of the outer surface is/are partially or completely covered by the sliding unit.

8. The magnetic armature according to claim 1, wherein an axial edge region of the outer surface or both axial edge regions of the outer surface is/are free of a covering by the sliding unit.

9. The magnetic armature according to claim 1, wherein the sliding unit has a multiplicity of sliding elements arranged separately from one another on the outer surface.

10. The magnetic armature according to claim 9, wherein at least one of the sliding elements preferably a plurality of the sliding elements and preferentially all sliding elements have an at least substantially circular contour or an at least substantially oval contour.

11. The magnetic armature according to claim 9, wherein at least one of the sliding elements, preferably a plurality of the sliding elements and preferentially all sliding elements, is/are extended in a strip-shaped or band-shaped manner.

12. The magnetic armature according to claim 11, wherein a main extension direction of at least one sliding element extended in a strip-shaped or band-shaped manner runs at least substantially parallel to an axial direction of the magnetic armature.

13. The magnetic armature according to claim 11, wherein a main extension direction of at least one sliding element extended in a strip-shaped or band-shaped manner runs obliquely to an axial direction of the magnetic armature.

14. The magnetic armature according to claim 11, wherein at least one of the sliding elements extended in a band-shaped or strip-shaped manner runs at least substantially spirally around the outer surface.

15. The magnetic armature according to claim 9, wherein at least a subset of the sliding elements exceeding the number two are arranged at least substantially regularly spaced apart from one another on the total lateral surface.

16. An electromagnetic actuator in particular a pneumatic valve, having a magnetic armature according to claim 1.

17. A method for producing a magnetic armature in particular according to claim 1, wherein, in at least one production step, a sliding unit for optimizing a tribological behavior of the magnetic armature such as reducing wear of the magnetic armature and/or friction with a magnetic armature guide unit of the electromagnetic actuator such as, for example, an armature guide tube or pole tube, is applied to an outer surface of the magnetic armature wherein, in the production step only part of a total lateral surface area of the magnetic armature in particular of an armature running surface of the magnetic armature is covered with the sliding unit.
